(19) United States
(12) Patent Application Publication
(10) Pub. No.: US 2010/0116823 A1
(43) Pub. Date: May 13, 2010

(54) HYDROFORMED FLUID CHANNELS

(75) Inventors: James David Felsch, Santa Clara, CA (US); Anthony Vesci, San Jose, CA (US); Michael P. Karazim, San Jose, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/267,191

(22) Filed: Nov. 7, 2008

(51) Int. Cl. B65D 6/10; B23P 15/26; B65D 6/40; B65D 90/02

(52) U.S. Cl. 220/62.11; 29/890.042; 29/890.044; 220/62.18

(57) ABSTRACT

A method and apparatus for providing a fluid channel on a surface that is subject to extreme temperatures is described. The embodiments described herein provide a fluid channel wherein the surface that is subject to the extreme temperatures forms one side of the fluid channel.

### BACKGROUND OF THE INVENTION

1. Field of the Invention

Embodiments of the invention relate to a method and apparatus for forming channels on a chamber that may be used for flowing a thermal transfer fluid.

2. Description of the Related Art

Portions of chambers that are subject to extreme temperature processes often need to be regulated and maintained at a specific temperature range. In one example, a chamber used for a high temperature process may need to be cooled to a lower temperature. Generally, the chamber will include at least one wall and thermal transfer fluids are flowed within or adjacent the chamber wall to remove excess heat. Various conventional methods to form conduits for flowing the thermal transfer fluids exist. One method includes forming channels in the chamber wall by gun-drilling, which is labor intensive and expensive. Another method includes coupling a tube to the chamber wall by clamps or welds. This method is also labor intensive and has inefficient heat transfer as a great portion of the tube is not in direct contact with the chamber wall.

Therefore, a need exists for an improved method and apparatus for forming thermal transfer fluid channels.

### SUMMARY OF THE INVENTION

Embodiments described herein provide a method and apparatus for providing a fluid channel on a surface that is subject to extreme temperatures. In one embodiment, a method for forming a fluid channel is described. The method includes providing a first member having a first thickness and a second member having a second thickness, the first thickness of the first member being at least about three times greater than the second thickness of the second member securing the first member to the second member by a continuous weld to form an initial volume circumscribed by the weld between the first member and the second member, and pressurizing the initial volume until the second member permanently deforms to expand the initial volume by at least three times.

In another embodiment, a method for forming a semiconductor processing chamber is described. The method includes providing a first member having a first thickness and a second member having a second thickness, the first thickness of the first member being at least about three times greater than the second thickness of the second member, securing the first member to the second member by a continuous weld, the weld defining a first volume, forming the first member and second member to define a cylinder, and pressurizing the first volume until the second member permanently deforms relative to the first member to include a second volume that is at least three times greater than the first volume.

In another embodiment, a sidewall for a chamber is described. The apparatus includes a first member having a first thickness, the first member comprising at least a portion of a chamber body, a second member having an second thickness, the first thickness being at least about three times greater than the second thickness, and a containment region formed between the first member and the second member by a continuous weld bead, the containment region comprising an outer surface of the first member and a portion of the second member inward of the continuous weld bead, the portion of the second member having a third thickness that is less than the second thickness.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is an isometric view of a chamber adapted for an extreme temperature process.

FIG. 1B is a cross-sectional view of one embodiment of a cooling channel disposed on the sidewall of the chamber of FIG. 1A.

FIG. 2A is an isometric view of one embodiment of a first assembly.

FIG. 2B is an isometric view of a second assembly of FIG. 2A.

FIG. 2C is an isometric view of a third assembly of FIG. 2A.

FIGS. 2D and 2E are cross-sectional views of a first fluid channel profile of the second assembly shown in FIG. 2B.

FIGS. 3A and 3B are cross-sectional views of a second fluid channel profile of the third assembly shown in FIG. 2C.

FIG. 4 is a schematic, cross-sectional diagram of vacuum processing chamber.

FIG. 5A is an isometric view of another embodiment of a first assembly.

FIG. 5B is an isometric view of a second assembly of FIG. 5A.

FIG. 5C is an isometric view of a third assembly of FIG. 5A.

FIG. 6 is a cross-sectional view of a first fluid channel profile of the second assembly shown in FIG. 5B.

FIG. 7 is a cross-sectional view of a second fluid channel profile of the second assembly shown in FIG. 5C.

FIG. 8 is a flow chart of a method for forming a fluid channel.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally provide a method and apparatus for providing a fluid channel on a surface that a user desires to be thermally controlled or thermally regulated. The embodiments described herein provide a channel wherein the surface that is to be thermally regulated forms one side of the channel. The channels as described herein may be used to flow a thermal transfer fluid, such as a cooling fluid or a heated fluid. The channels as described herein provide an increased surface area for contact with the thermal transfer fluid and the thermal transfer fluid is in direct contact with the surface that is to be thermally regulated. For ease of description, embodiments described herein will be described with reference to flowing a cooling fluid adjacent a surface that is subject to high temperatures to remove heat from the surface. However, embodiments of the invention are not limited to removing excess heat and may be equally applicable to flowing a heated fluid to raise or maintain the temperature of the surface.

In some embodiments, a fluid channel may be formed on or coupled to semiconductor substrate process chambers. For example, suitable process chambers may include vacuum processing chambers, thermal processing chambers, plasma processing chambers, annealing chambers, deposition chambers, etch chambers, implant chambers, or the like. Examples of suitable chambers which may benefit from embodiments described herein include the QUANTUM® X implant chamber, and the CENTURA® RP EPI chamber, as well as other chambers available from Applied Materials, Inc. of Santa Clara, Calif. Embodiments described herein may be beneficially utilized on chambers available from other manufacturers as well.

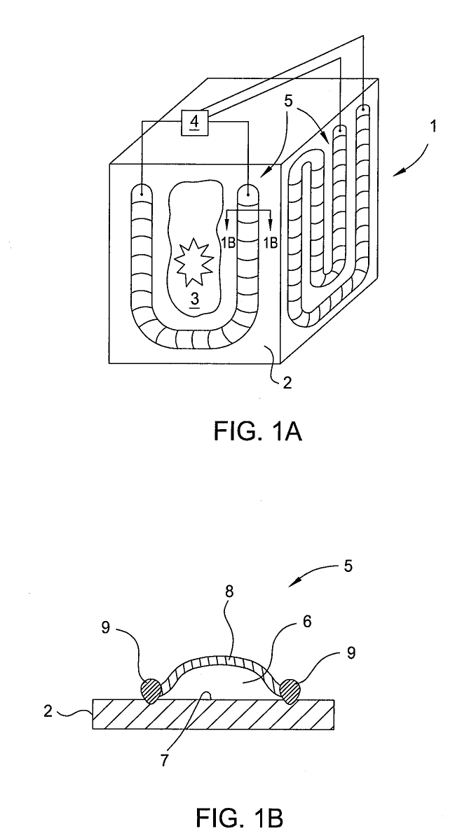

FIG. 1A is an isometric view of an enclosure or chamber 1 having a body including sidewalls 2 that define an interior volume 3. In one embodiment, the interior volume is configured for containing a high temperature process. The chamber 1 includes a body having sidewalls 2 that define an interior volume 3 configured for a high temperature process. The high temperature process may be a deposition process, an annealing process or other processes where high temperatures are generated or maintained. The high temperature process within the interior volume transfers heat to the sidewalls 2.

The heat transferred to the sidewalls 2 may be regulated for process control and/or to maintain the temperature of the sidewalls 2 within operational limits. To regulate the temperature of the sidewall 2, heat from the sidewalls 2 is transferred by flowing a cooling fluid from a coolant source 4 through a cooling channel 5 disposed on the sidewall 2. The cooling fluid may be water, de-ionized water (DIW), ethylene glycol, helium (He), nitrogen (N₂), argon (Ar) or other cooling fluids in liquid or gas phase.

FIG. 1B is a cross-sectional view of one embodiment of a cooling channel 5 disposed on the sidewall 2 of the chamber of FIG. 1A. The cooling channel 5 includes a cavity 6 formed by a surface 7 of the sidewall 2 and a convex member 8. The convex member 8 is secured to the sidewall 2 by a continuous weld bead 9 and the cavity 6 is disposed between the continuous weld bead 9. The continuous weld bead as used herein refers to a deposit of filler metal and/or an area of fusion produced by one or more passes of a welding device. The cooling fluid from the coolant source 4 flows in the cavity 6 in direct contact with the surface 7 of the sidewall 2 to transfer heat from the sidewall 2.

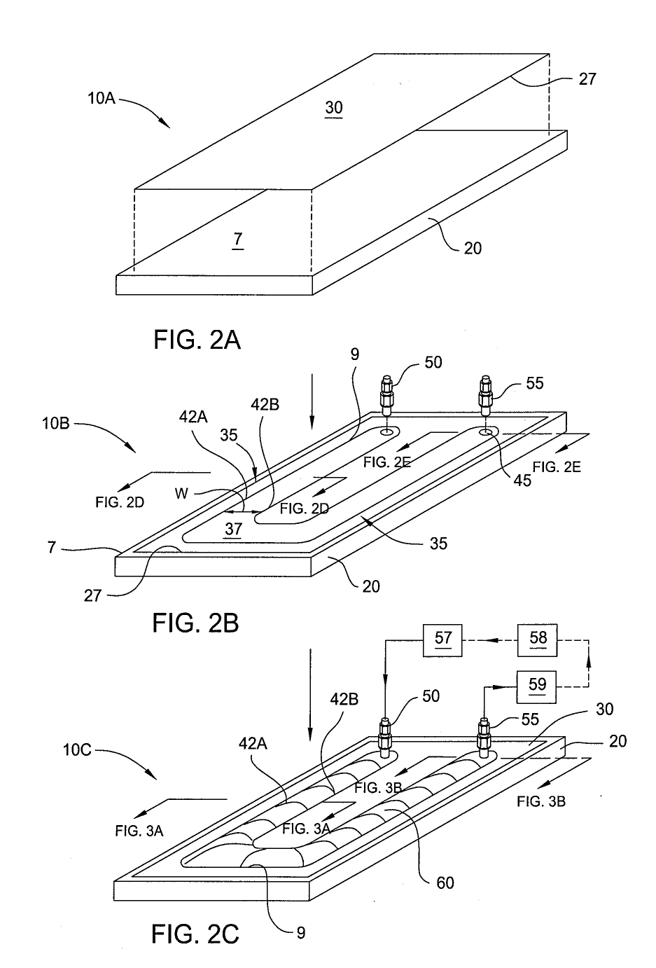

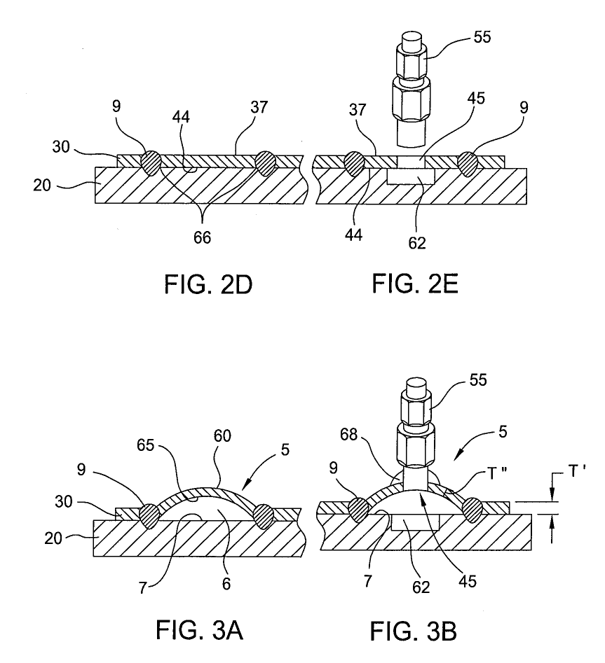

FIG. 2A is an isometric view of one embodiment of a first assembly 10A illustrating an initial fabrication step to form a cooling channel 5 (FIGS. 1A and 1B). The first assembly 10A includes a base or first plate 20 which may be joined with a chamber or form a sidewall 2 of a chamber 1 (FIG. 1A). The first plate 20 includes a surface 7 that is thermally conductive and in thermal communication with the extreme temperatures within the enclosure. Although the first plate 20 is rectangular and includes a flat or planar surface 7 as shown, the first plate 20 may be any irregular shape and the surface 7 may be non-planar. In one embodiment, the surface 7 forms an exterior surface of the first plate 20 after further fabrication and coupling with other sidewalls to form the chamber or enclosure. In this embodiment, the surface 7 of the first plate 20 is opposing a surface that is exposed to the interior of the chamber. Alternatively, the surface 7 may be an interior surface of the chamber after further fabrication.

The first plate 20 may be made of any thermally conductive material. Examples include steel, stainless steel, aluminum or other conductive material. In one embodiment, the material of the plate 20 is suitable to withstand temperatures in excess of 100 degrees Celsius. In one embodiment, the first plate 20 may be made of any material that is capable of being welded by a welding process, such as electron beam welding or laser welding, among other welding methods.

In a first step in the initial fabrication of a cooling channel, the first assembly 10A includes a second plate 30 that is brought into proximity with the surface 7 of the first plate 20. The second plate 30 may be positioned on the first plate to contact the surface 7. After the second plate 30 has been positioned as desired, the first plate 20 and second plate 30 may be held together by clamps or tack welded along a perimeter 27 of the second plate 30. The clamping and/or tack welding ensures contact between the first plate 20 and second plate 30 and prevents the second plate 30 from moving relative to the first plate 20.

The second plate 30 may be made of any thermally conductive material that may be similar or different from the material of the first plate 20. Examples include steel, stainless steel, aluminum or other conductive material suitable to withstand temperatures in excess of 100 degrees Celsius. In one embodiment, the second plate 30 may be made of a metallic material that may be welded by electron beam welding or laser welding, among other welding methods. Likewise, the second plate 30 may be shaped similarly to the shape of the first plate 20. Alternatively, the shape of the second plate 30 may be different than the shape of the first plate 20. Additionally, if the first plate 20 includes openings, cut-outs or structures protruding from the surface 7 (not shown), the second plate 30 may include openings, slots, chamfers, or cut-outs (not shown) formed therein configured to fit around or provide access to the openings, cut-outs or structures disposed on the first plate 20.

In this embodiment, the second plate 30 is a sheet of material sized slightly smaller than the first plate 20. In other embodiments, the second plate 30 may be larger than the first plate 20. The second plate 30 is rectangular and includes a length and a width that is slightly smaller than the length and width of the first plate 20. The second plate 30 is thinner than the first plate 20. In one embodiment, the thickness of the first plate 20 is at least 3 times thicker than the thickness of the second plate 30.

FIG. 2B is an isometric view of a second assembly 10B made from the first assembly 10A, which illustrates an intermediate fabrication step to form a cooling channel 5 as shown in FIG. 1A. After the second plate 30 is brought into proximity with and is at least partially contacting the surface 7, a continuous weld bead 9 is laid in an elongated pattern 35 to join the first plate 20 and second plate 30. The pattern 35 may be any desired pattern that facilitates a desired first fluid channel profile 37 on both of the first plate 20 and second plate 30. The pattern 35 may be a suitable shape configured to provide efficient heat transfer from the surface 7. For example, the pattern 35 may include at least one 180 degree curve or bend to form a “C” or “U” shape, form a serpentine shape or zigzag pattern, and combinations thereof.

In one embodiment, the first fluid channel profile 37 is defined as a width W between adjacent portions of the continuous weld bead 9. In one example, the width W is the area between adjacent bead segments, such as bead segments 42A and 42B. In one embodiment, the area between the bead segments 42A and 42B, and any portion of the surface 7 and second plate 30 that is not joined, is a containment region (shown as 66 in FIG. 2D). The second assembly 10B also shows the layout for an inlet fitting 50 and an outlet fitting 55 to be disposed in respective holes 45 formed in the second plate 30. The inlet fitting 50 and outlet fitting 55 provide a fluid between the first plate 20 and second plate 30 to form the cooling channel as defined by the first fluid channel profile 37.

FIG. 2C is an isometric view of a third assembly 10C made from the second assembly 10B, which illustrates a final fabrication step to form a cooling channel 5 as shown in FIG. 1A. In this embodiment, the inlet fitting 50 and outlet fitting 55 are coupled to the holes 45 (not shown in FIG. 2B). The inlet fitting 50 is connected to a pump 57 and the outlet fitting 55 is coupled to a fluid reservoir 58. A valve 59 is disposed between the outlet fitting 55 and the fluid reservoir 58. A fluid, such as water, is pumped from the fluid reservoir 58 through the inlet fitting 50 and into an interstitial space 44 (FIG. 2D) defined between the first plate 20 and the second plate 30 circumscribed by the continuous weld bead 9. The valve 59 and/or pump 57 may be adjusted to build pressure in the interstitial space 44 defined between the first plate 20 and second plate 30. A sufficient pressure is provided to deform the second plate 30 relative to the first plate 20 and form a second fluid channel profile 60.

FIGS. 2D and 2E are cross-sectional views of the first fluid channel profile 37 disposed on the first plate 20 and second plate 30. Although the second plate 30 is welded to the first plate 20 by the continuous weld bead 9, a containment region 66 is formed between the continuous weld bead 9 and portions of the surface 7 and second plate 30 that are not joined. The containment region 66 includes a gap or interstitial space 44 that remains between the surface 7 of the first plate 20 and the interior surface of the second plate 30. The interstitial space 44 allows fluid to flow therein and subsequently deflect the portion of the second plate 30 to form a cavity therebetween. FIG. 2E shows the layout of the outlet fitting 55 which is coupled to the hole 45 as shown in FIG. 3B. The outlet fitting 55 may be threaded or welded to the second plate 30. If the outlet fitting 55 is welded to the second plate 30, a spot face 62 may be formed in the surface 7 to prevent penetration of the weld to the first plate 20. One or both of the hole 45 and spot face 62 may be formed in the second plate 30 and first plate 20, respectively, prior to joining the second plate 30 with the first plate 20. While not shown, the inlet fitting 50 may be coupled to the second plate 30 in the same manner as the outlet fitting 55.

FIGS. 3A and 3B are cross-sectional views of the second fluid channel profile 60 disposed on the first plate 20 and second plate 30. During pressurization of the interstitial space 44 as described in FIG. 2C, the second plate 30 is deflected and a cavity 6 is formed between an interior surface 65 of the second plate 30 and the surface 7 of the first plate 20. After the second plate 30 is deflected to form a cavity 6 having a desired volume, a fluid channel 5 is formed on the surface 7 of the first plate 20. The surface 7 of the first plate 20 may not be deflected and remain in the same shape due to the thickness of the first plate 20. The second plate 30 includes an initial first thickness T′ but may be stretched during the deflection to a second thickness T″ between the continuous weld bead 9 that is less than the first thickness T′. FIG. 3B shows the outlet fitting 55 coupled to the hole 45 by a weld 68.

In one embodiment, the interstitial space 44, which is the area interior of the continuous weld bead 9 and portions of the surface 7 and second plate 30 that is not joined between the continuous weld bead 9, includes a first volume or cross-sectional area and the cavity 6 that is formed includes a second volume or cross-sectional area that is at least 2 times greater than the first volume. For example, the interstitial space 44 may include a slight gap between the second plate 30 and the surface 7 to define a minimal cross-sectional area that is slightly greater than 0, such as about 0.1 cm², and the cavity 6 that is formed thereafter may include a second cross-sectional area that is at least 200 times greater, for example about 20 cm². In some embodiments, the cavity 6 that is formed includes a second volume or cross-sectional area that is at least 300 times greater than the first volume or cross-sectional area.

While the embodiments described above are directed to a rectangular or cube-shaped chamber 1 as shown in FIG. 1A with rectangular and/or planar sidewalls, alternative embodiments may be utilized to form fluid channels in chambers or enclosures having other shapes. For example, prior to joining the first plate 20 with the second plate 30, the second plate 30 may be bent using a sheet metal brake to form corners or angles in the second plate 30 that substantially match the corners or angles of the chamber or enclosure. Additionally, if the chamber or enclosure includes non-linear or arcuate sidewalls, the second plate may be rolled to substantially match the curvature of the sidewalls prior to joining the second plate 30 to the first plate 20. Alternatively, if the chamber or enclosure formed from a first plate 20 is to be cylindrical in final form, a planar second plate 30 may be joined to a planar first plate 20 and the first fluid channel profile 37 may be formed by the continuous weld bead while both plates 20 and 30 are flat. Thereafter, both the first plate 20 and second plate 30 may be rolled to a desired radius and the first plate 30 may be seam welded. After rolling both plates 20 and 30, the inlet fitting and outlet fitting may be coupled to the containment region and deflected to form a fluid channel.

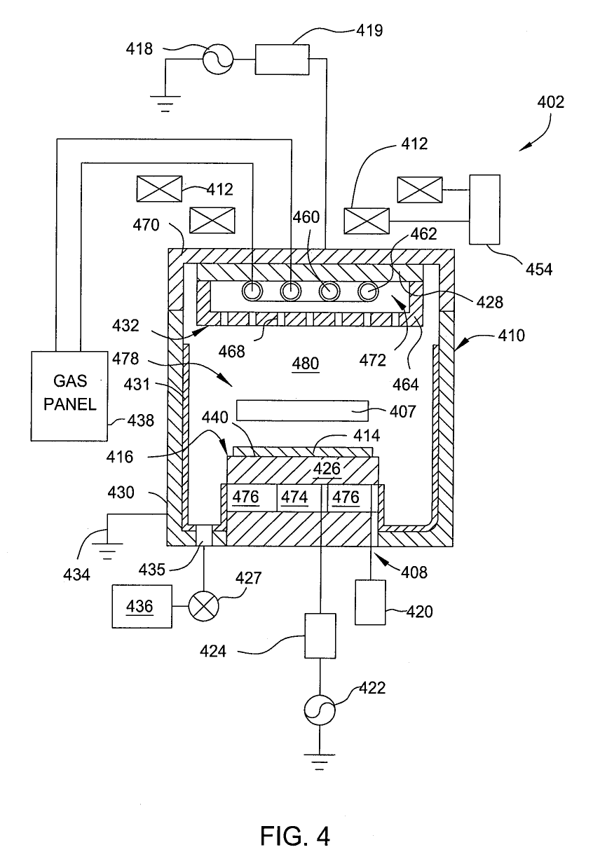

FIG. 4 is a schematic, cross-sectional diagram of vacuum processing chamber 402 that may be configured for a deposition or an etch process on a substrate 414. In one embodiment, the vacuum processing chamber 402 includes a chamber body 410 having conductive chamber sidewall 430 that includes portions that are non-linear or arcuate. One example of a vacuum processing chamber 402 in which embodiments described herein may be beneficially utilized is an ENABLER® processing chamber available from Applied Materials, Inc., of Santa Clara, Calif. It is also contemplated some embodiments described herein may be used to advantage in other processing chambers configured for other process, including those from other manufacturers.

The chamber body 410 includes a lid 470 and a bottom 98 coupled to the conductive chamber sidewall 430 to enclose an interior volume 478 defined within the chamber body 410. The conductive chamber sidewall 430 is connected to an electrical ground 434 and at least one solenoid segment 412 is positioned exterior to the conductive chamber sidewall 430. The solenoid segment(s) 412 may be selectively energized by a DC power source 454 that is capable of producing at least 5V to provide a control metric for plasma processes formed within the vacuum processing chamber 402. A ceramic liner 431 is disposed within the interior volume 478 to facilitate cleaning of the chamber 402. The byproducts and residue of a deposition or an etch process may be readily removed from the liner 431 at selected intervals.

A substrate support pedestal 416 is disposed on the bottom 98 of the vacuum processing chamber 402 below a gas diffuser or showerhead 432. A process region 480 is defined within the interior volume 478 between the substrate support pedestal 416 and the showerhead 432. A port 97 may be formed in the conductive chamber sidewall 430 to facilitate transfer of the substrate to the process region 480. The substrate support pedestal 416 may include an electrostatic chuck 426 for retaining a substrate 414 on a surface 49 of the pedestal 416 beneath the showerhead 432 during processing. The electrostatic chuck 426 is controlled by a DC power supply 420. The support pedestal 416 may be coupled to a radio frequency (RF) bias source 422 through a matching network 424. The bias source 422 is generally capable of producing a RF signal having a tunable frequency of 50 kHz to 13.56 MHz and a power of between 0 and 5000 Watts. Optionally, the bias source 422 may be a DC or pulsed DC source.

The interior of the vacuum processing chamber 402 is a high vacuum vessel that is coupled to a vacuum pump 436 through an exhaust port 435 formed through the conductive chamber sidewall 430 and/or the chamber bottom 98. A throttle valve 427 disposed in the exhaust port 435 is used in conjunction with the vacuum pump 436 to control the pressure inside the vacuum processing chamber 402. The showerhead 432 includes at least two gas distributors 460, 462, a mounting plate 428 and a gas distribution plate 464. The gas distributors 460, 462 are coupled to one or more gas panels 438 through the lid 470 of the vacuum processing chamber 402. The flow of gas through the gas distributors 460, 462 may be independently controlled. Although the gas distributors 460, 462 are shown coupled to a single gas panel 438, it is contemplated that the gas distributors 460, 462 may be coupled to one or more shared and/or separate gas sources. Gases provided from the gas panel 438 are delivered into a region 472 defined between the plates 428, 464, then exit through a plurality of holes 468 formed through the gas distribution plate 464 into the process region 480 where a plasma is formed. The showerhead 432 is adapted to deliver gas into the process region 480 with an asymmetry that offsets the asymmetric effects of the chamber conductance on plasma location and/or the delivery of ions and/or reactive species to the surface of the substrate during processing. The mounting plate 428 is coupled to the lid 470 opposite the support pedestal 416. The mounting plate 428 is fabricated from or covered by a RF conductive material. The mounting plate 428 is coupled to a RF source 418 through an impedance transformer 419 (e.g., a quarter wavelength matching stub). The source 418 is generally capable of producing a RF signal having a tunable frequency of about 162 MHz and a power between about 0 and 2000 Watts. The mounting plate 428 and/or gas distribution plate 464 is powered by the RF source 418 to promote and/or maintain the plasma formed from the process gas present in the process region 480 of the vacuum processing chamber 402.

The plasma formed in the process region 480 may reach temperatures in excess of 400 degrees Celsius. The temperature in the process region 480 is controlled or supplemented by various temperature control devices that are disposed in or around the vacuum processing chamber 402. The support pedestal 416 may include inner and outer temperature regulating zones 474, 476 to control the temperature of the support pedestal 416 and the substrate 414 supported thereon. Each of the inner and outer temperature regulating zones 474, 476 may include at least one temperature regulating device, such as a resistive heater or a conduit for circulating coolant, so that the radial temperature gradient of the substrate disposed on the pedestal 416 may be controlled. To remove or provide heat to the conductive chamber sidewall 430, a fluid channel may be coupled to the conductive chamber sidewall 430 as described below.

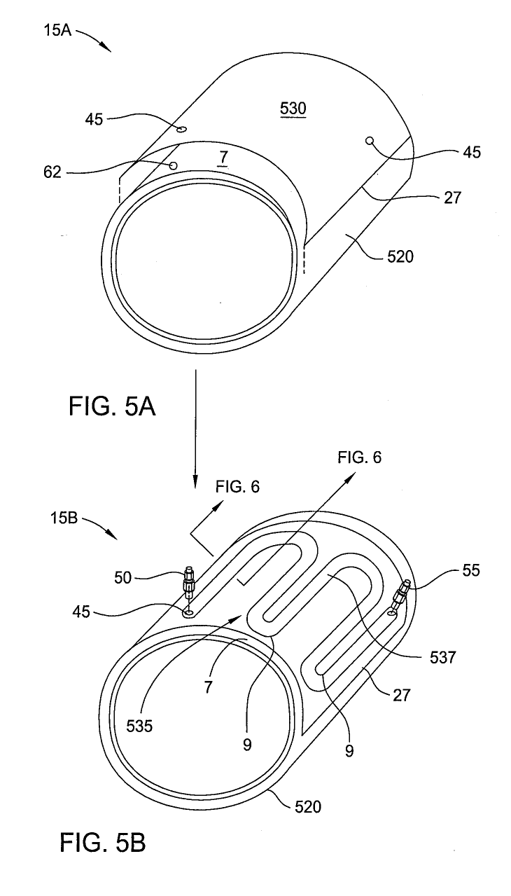

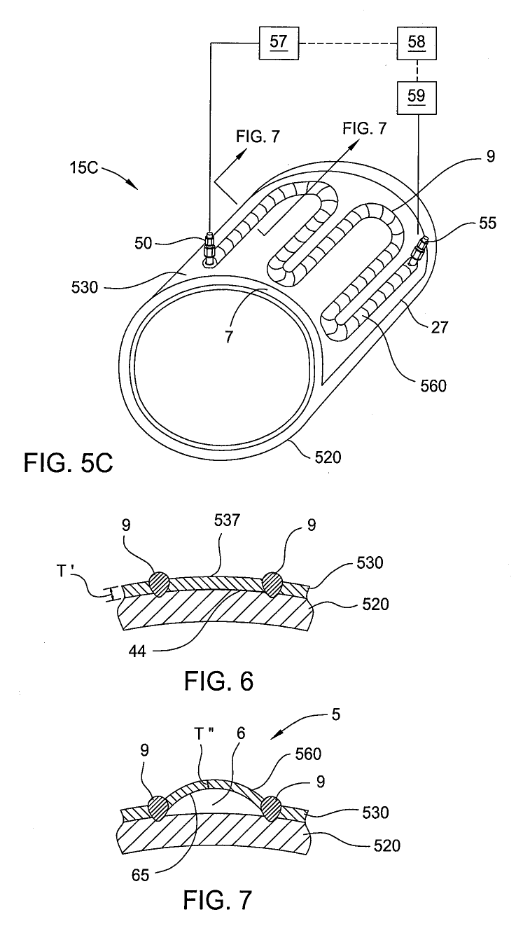

FIG. 5A is an isometric view of another embodiment of a first assembly 15A illustrating an initial fabrication step to form a cooling channel on the vacuum processing chamber 402 of FIG. 4. The first assembly 15A is shown in an initial stage in the manufacture of the vacuum processing chamber 402 such that the material to form the conductive chamber sidewall 430 of the vacuum processing chamber 402 is depicted as a first member 520 that is in the general shape of a cylinder. The first member 520 includes the surface 7 which forms one side of the fluid channel. A second member 530 is shown adjacent the first member 520 that includes a shape that is substantially similar to the shape of the first member 520. The first member may be made of a conductive metal, such as aluminum or stainless steel as described above in reference to the first plate 20 and the second member 530 may be a sheet of material as described above in reference to the second plate 30. In one embodiment, the second member 530 has been rolled to include a radius that substantially matches a radius of the surface 7.

In this embodiment, a plurality of spot faces 62 (only one is shown in this view) have been pre-formed in the first member 520 and a plurality of holes 45 that align with the spot faces 62 have been pre-formed in the second member 530. In a first step in the initial fabrication of a cooling channel, the second member 530 is brought into proximity with the surface 7 of the first member 520. The second member 530 may be positioned on the first member 520 to be in contact with the surface 7. After the second member 530 has been positioned as desired on the first member 520, the first member 520 and second member 530 may be held together by clamps or tack welded along a perimeter 27 of the second member 530. The clamping and/or tack welding ensures contact between the first member 520 and second member 530 and prevents the second member 530 from moving relative to the first member 520.

FIG. 5B is an isometric view of a second assembly 15B made from the first assembly 15A, which illustrates an intermediate fabrication step to form a cooling channel. After the second member 530 is brought into proximity with and in contact with the surface 7, a continuous weld bead 9 is laid in a pattern 535 to join the first member 520 and second member 530. The pattern 535 may be a pattern selected to regulate the temperature of the chamber wall as desired. The pattern 535 defines a first fluid channel profile 537 on both of the first member 520 and second member 530. The second assembly 15B also shows the layout for an inlet fitting 50 and an outlet fitting 55 to be disposed in respective holes 45 formed in the second member 530. The inlet fitting 50 and outlet fitting 55 provide a fluid between the first member 520 and second member 530 to form the cooling channel as defined by the first fluid channel profile 537. In one embodiment, portions of the second member 530 outside of the first fluid channel profile 537 and the continuous weld bead 9 may be trimmed off.

FIG. 5C is an isometric view of a third assembly 15C made from the second assembly 15B, which illustrates a final fabrication step to form a cooling channel 5. In this embodiment, the inlet fitting 50 and outlet fitting 55 are coupled to the holes 45 (not shown in this view). The inlet fitting 50 is connected to a pump 57 and the outlet fitting 55 is coupled to a fluid reservoir 58. A valve 59 is disposed between the outlet 55 and the fluid reservoir 58. A fluid, such as water, is pumped from the fluid reservoir 58 through the inlet fitting 50 and into an interstitial space 44 (FIG. 6) between the first member 520 and second member 530. When a sufficient pressure is reached in the interstitial space 44, the second member 530 is deformed outward to form a second fluid channel profile 560.

FIGS. 6 and 7 are respective cross-sectional views of the first fluid channel profile 537 and second fluid channel profile 560 disposed on the first member 520 and second member 530. During pressurization of the interstitial space 44 as described in FIG. 5C, the second member 530 is deflected and a cavity 6 is formed between an interior surface 65 of the second member 530 and the surface 7 of the first member 520. After the second member 530 is deflected to create a cavity 6 having a desired volume, a fluid channel 5 is formed on the surface 7 of the first member 520. The surface 7 of the first member 520 may not be deflected and remain in the same arcuate shape due to the thickness of the first member 520 relative to the thickness of the second member 530. As such, the second member 530 includes an initial first thickness T′ but may be stretched during the deflection to a second thickness T″ between the continuous weld bead 9 that is less than the first thickness T′.

After the fluid channel 5 has been formed on the first member 520, further fabrication of the vacuum processing chamber 402 may commence. The inlet fitting 50 and outlet fitting 55 used for providing a fluid to the interstitial space 44 for deflection may be coupled to the coolant source 4 (FIG. 1A) to provide a cooling fluid to the fluid channel 5 to transfer heat from the surface 7 in a manner that regulates the temperature of the first member 520.

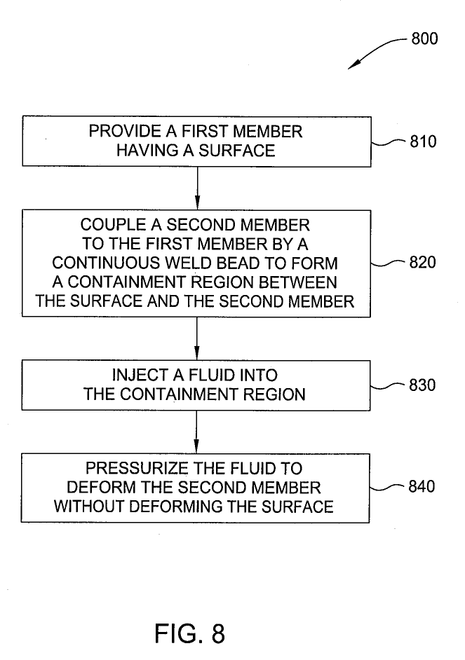

FIG. 8 is a flow chart of a method 800 for forming a fluid channel 5. At 810, a base or first member having a surface 7 is provided, such as the first plate 20. Step 820 describes coupling the first member to a second member, such as the second plate 30, by a continuous weld bead. The penetration of the continuous weld bead 9 should be at least equal to or greater than the thickness of the second member. The continuous weld bead forms a first fluid channel profile that provides a joining of the first member and second member such that a containment region 66 is formed interior of the continuous weld bead. The first fluid channel profile may include opposing weld beads in a straight and parallel relation, include one or more bends, one or more U-shaped or angled turns, or any pattern that provides a containment region interior of the continuous weld bead.

At 830, a fluid is injected into the containment region. The fluid may be water that is provided to an inlet fitting 50 coupled to the second member and flows to an outlet fitting 55 coupled to the second member. In order to remove any gas, such as air, that may be present in the containment region 66, the outlet fitting 55 may be elevated above the inlet fitting 50 to allow air to escape through the outlet fitting 55 during the fluid injection. At 840, the fluid is pressurized in the containment region by a pump and/or a valve coupled to the outlet fitting 55. The pressure of the water may be varied until the second member is inflated or deformed. The deformation may be continuously monitored until the second member has been deformed a suitable amount. The fluid injection may then be discontinued and the pump and valve removed from the inlet fitting and outlet fitting. The inlet fitting and outlet fitting may then be utilized to provide a heat transfer fluid to the formed fluid channel.

### EXAMPLE

A fluid channel 5 was formed on a semiconductor substrate processing chamber according to embodiments described herein. The first member, which was a sidewall of the processing chamber in a flat or planar shape, was grade 304 stainless steel having a thickness of about 0.25 inches (6.35 mm). The second member was a sheet of grade 304 stainless steel having a thickness of 0.029 inches (0.736 mm). Spot faces of about 0.030 inches (0.762 mm) deep were formed in the first member and holes for the inlet fitting and outlet fitting were formed in the second member. While both the first member and the second member were substantially flat, the second member was brought into contact with the first member and the perimeter of the second member was tacked to the first member.

A continuous weld bead was laid in a desired pattern to join the first member and second member. An X/Y table was used to move the first member and second member to lay the continuous weld bead. A first fluid channel profile was formed by the continuous weld bead having a width between adjacent weld beads of about 50 mm. The previously formed holes for the inlet fitting and outlet fitting were within the first fluid channel profile. After the first fluid channel profile was formed, the first member and second member were rolled to a desired radius and a seam weld was made to form a cylindrical sidewall.

The inlets and outlets were welded to the previously formed holes in the second member. A fluid reservoir of water was used having a capacity of about 5 gallons. A pump capable of providing about 2000 psi (13.8 MPa) of pressure was coupled to the inlet fitting with a length of copper tubing. A metering valve was coupled to the outlet fitting by another length of copper tubing and the metering valve was fully opened. The first and second members were tilted to elevate the outlet fitting above the remainder of the assembly to allow air to escape as water was flowed through the inlet fitting. After air was purged from the outlet fitting, the metering valve was closed to allow the pump to pressurize the interstitial space defined by the first fluid channel profile. Deflection of the second member was monitored until a desired second fluid channel profile was created by the pressurized water. In this example, the cross-sectional area of the second fluid channel profile was about 196 cm², which would be substantially equal to the cross-sectional area of a tube having a ½ inch (12.7 mm) inside diameter. The pump was turned off and the pump and metering valve was disconnected from the inlet fitting and outlet fitting. The cylindrical assembly having the fluid channel formed therein was coupled with other components to form a semiconductor substrate processing chamber. The inlet fitting and outlet fitting was coupled to a fluid source to provide cooling fluid to the fluid channel and thus transfer heat from the semiconductor substrate processing chamber.

In the embodiments described above, a method of forming a fluid channel 5 is provided. The method described above provides a fluid channel that is formed in-situ on a chamber wall during an initial stage of chamber fabrication. Forming of the fluid channel as described above requires no specialized forms, molds or dies that may be needed to form conventional channels. The fluid channel 5 described above is less labor intensive and can be fabricated in less time than conventional methods, such as gun drilling and welding or clamping tubing to a sidewall. The method as described above is also less expensive than the conventional methods. In the example described above, a savings of greater than 50 percent was realized as compared to welded or clamped-on tubing. Additionally, since the surface to be thermally regulated is in direct contact with the heat transfer fluid, the fluid channel 5 provides a very efficient means for temperature control.

While the foregoing is directed to embodiments of the invention, other and further embodiments of the invention may be devised without departing from the basic scope thereof, and the scope thereof is determined by the claims that follow.

What is claimed is:

1. A method for forming a fluid channel, comprising:
providing a first member having a first thickness and a second member having a second thickness, the first thickness of the first member being at least about three times greater than the second thickness of the second member;
securing the first member to the second member by a continuous weld to form an initial volume circumscribed by the weld between the first member and the second member; and
pressurizing the initial volume until the second member permanently deforms to expand the initial volume by at least three times.

2. The method of claim 1, wherein securing the members further comprises:
defining an elongated pattern with the continuous weld.

3. The method of claim 2, wherein the elongated pattern includes at least one 180 degree bend to define a “U” shape.

4. The method of claim 2, wherein the elongated pattern defines a serpentine shape.

5. The method of claim 2, further comprising:
forming ports through the second member at opposite ends of the elongated pattern.

6. The method of claim 1, wherein the first member has an initial shape and the initial shape is unchanged after pressurizing.

7. The method of claim 6, wherein the initial shape is planar.

8. The method of claim 6, wherein the initial shape is arcuate.

9. The method of claim 6, wherein the first member is a portion of a chamber body of a vacuum processing chamber.

10. A method for forming a semiconductor processing chamber, comprising:
providing a first member having a first thickness and a second member having a second thickness, the first thickness of the first member being at least about three times greater than the second thickness of the second member;
securing the first member to the second member by a continuous weld, the weld defining a first volume;
forming the first member and second member to define a cylinder; and
pressurizing the first volume until the second member permanently deforms relative to the first member to include a second volume that is at least three times greater than the first volume.

11. The method of claim 10, further comprising:
forming ports through the second member at a location interior of and at opposite ends of the continuous weld.

12. The method of claim 11, further comprising:
coupling an inlet fitting and an outlet fitting to respective ports, each of the inlet fitting and outlet fitting in fluid communication with the second volume.

13. The method of claim 12, further comprising:
coupling the inlet fitting to a cooling fluid supply.

14. The method of claim 10, wherein the first member has an initial shape and the initial shape is unchanged after pressurizing.

15. The method of claim 14, wherein the initial shape is planar.

16. The method of claim 14, wherein the initial shape is arcuate.

17. A sidewall for a chamber, comprising:
a first member having a first thickness, the first member comprising at least a portion of a chamber body;
a second member having an second thickness, the first thickness being at least about three times greater than the second thickness; and
a containment region formed between the first member and the second member by a continuous weld bead, the containment region comprising an outer surface of the first member and a portion of the second member inward of the continuous weld bead, the portion of the second member having a third thickness that is less than the second thickness.

18. The apparatus of claim 17, wherein the containment region defines an elongated pattern.

19. The apparatus of claim 18, wherein the elongated pattern includes at least one 180 degree bend to define a “U” shape.

20. The apparatus of claim 18, wherein the elongated pattern defines a serpentine shape.

21. The apparatus of claim 17, further comprising:
an inlet port and an outlet port formed in the second member, each of the inlet port and outlet port in fluid communication with the containment region.

22. The apparatus of claim 21, further comprising:
an inlet fitting and an outlet fitting coupled to the inlet port and the outlet port, respectively.

23. The apparatus of claim 22, further comprising:
a cooling fluid supply coupled to the inlet fitting.
